(19) United States
(12) Patent Application Publication
(10) Pub. No.: US 2026/0021658 A1
(43) Pub. Date: Jan. 22, 2026

(54) INKJET PRINTING SYSTEM, METHOD FOR MONITORING NOZZLE STATE THEREOF, AND ELECTRONIC DEVICE

(71) Applicants: Samsung Display Co., LTD., Yongin-si (KR); SOONCHUNHYANG UNIVERSITY INDUSTRY ACADEMY COOPERATION FOUNDATION, Asan-si (KR)

(72) Inventors: Jung Han SEO, Yongin-si (KR); Kye Si KWON, Seoul (KR); Woo Yong SUNG, Yongin-si (KR); Seung Yong SONG, Yongin-si (KR); Jin Sol LEE, Incheon (KR); Jeong Yeop JO, Ansan-si (KR)

(73) Assignees: Samsung Display Co., LTD., Yongin-si (KR); SOONCHUNHYANG UNIVERSITY INDUSTRY ACADEMY COOPERATION FOUNDATION, Asan-si (KR)

(21) Appl. No.: 19/276,164

(22) Filed: Jul. 22, 2025

(30) Foreign Application Priority Data
Jul. 22, 2024 (KR) 10-2024-0096682

(51) Int. Cl. B41J 2/045

(52) U.S. Cl. CPC B41J 2/0451; B41J 2/04541; B41J 2/04548; B41J 2/0455; B41J 2/0457; B41J 2/04581; B41J 2/04588

(57) ABSTRACT

An inkjet printing system includes: an inkjet head including a plurality of nozzles that eject ink; a driver that controls driving of the plurality of nozzles; an impedance converter located between the driver and the inkjet head, the impedance converter having an impedance which varies based on a magnitude of an input voltage provided by the driver; and a self-sensing circuit part connected to an input terminal of the inkjet head and an output terminal of the impedance converter, the self-sensing circuit part measuring a self-sensing voltage for each nozzle.

### CROSS-REFERENCE TO RELATED APPLICATION(S)

This application claims priority to and benefits of Korean Patent Application No. 10-2024-0096682 under 35 U.S.C. § 119, filed on Jul. 22, 2024 in the Korean Intellectual Property Office (KIPO), the entire contents of which are incorporated herein by reference.

### TECHNICAL FIELD

Embodiments relate to an inkjet printing system and a method for monitoring nozzle states thereof.

### BACKGROUND

The development of multimedia has increased the importance of display devices. Since the demand for cost reduction has also grown due to intensified competition in the display industry, research and efforts to apply inkjet printing techniques to display manufacturing have been steadily increasing. For example, the inkjet printing technique, which provides cost-effective and high-quality printing, is gaining attention in the display manufacturing field. Its applications have expanded to areas such as a color filter, liquid crystal coating, electrode printing, black bezel printing and the like. In another example, the inkjet printing technique is applied to processes for manufacturing organic light emitting displays (OLEDs), including a thin film encapsulation (TFE) process, a pixel process (e.g., a process of forming red, green, and blue (RGB) light emitting layers by depositing a polymer material), a process of printing OLED common layers (e.g., a hole injection layer (HIL), a hole transport layer (HTL), etc.) and the like.

As the application range of the inkjet printing technique expands to manufacturing processes, ensuring the reliability of ink jetting through nozzles has become a critical issue. The inkjet printing technique may include a large number of nozzles (e.g., 1,000 or more) in a single inkjet head to enhance productivity and may use multiple inkjet heads simultaneously. As the number of nozzles increases, challenges in nozzle maintenance may arise. Various methods, such as directly ejecting ink and analyzing the ejected ink using a separate vision system, have been proposed for monitoring nozzle states (e.g., detecting defects). However, these existing monitoring methods may require significant time and lead to considerable ink waste. Therefore, a method for quickly, accurately, and efficiently monitoring nozzle states of an inkjet printing system is desirable.

### SUMMARY

According to aspects of embodiments, an inkjet printing system and a method of monitoring states of nozzles (via signals from piezo actuators) are provided, which may improve the speed, accuracy, and/or efficiency of nozzle state monitoring.

In aspects of embodiments, an inkjet printing system and method for both monitoring nozzle states and controlling the driving voltage for jetting are provided.

In aspects of embodiments, an inkjet printing system and a method for monitoring nozzle states are provided, which may obtain a high-quality self-sensing signal while minimizing distortion of driving voltage.

According to an embodiment, an inkjet printing system may comprise: an inkjet head including a plurality of nozzles that eject ink; a driver that controls driving of the plurality of nozzles; an impedance converter located between the driver and the inkjet head, the impedance converter having an impedance which varies based on a magnitude of an input voltage of the impedance converter provided by the driver; and a self-sensing circuit part connected to an input terminal of the inkjet head and an output terminal of the impedance converter, the self-sensing circuit part measuring a self-sensing voltage for each nozzle.

According to an embodiment, the impedance converter may have a low impedance in case that the input voltage of the impedance converter is within the jetting voltage range and a high impedance in case that the input voltage of the impedance converter approaches zero after jetting.

According to an embodiment, the impedance converter may include a class B amplifier having a complementary push-pull structure, a class AB amplifier based on a PN diode, or a class AB amplifier based on a Schottky diode.

According to an embodiment, the driver may include a driving signal generator that generates a driving signal of a designated waveform for driving the nozzles.

According to an embodiment, the driver may further include a power amplifier that amplifies the generated driving signal.

According to an embodiment, the self-sensing circuit part may include: a differential amplifier that extracts a self-sensing signal by removing a driving voltage from an output voltage signal of the impedance converter; a signal processor that amplifies and filters the extracted self-sensing signal; and a data collector that collects and stores the amplified and filtered self-sensing signal.

According to an embodiment, the impedance converter may be embedded in the driver.

According to an embodiment, the self-sensing circuit part may be embedded in the driver.

According to an embodiment, the impedance converter may be embedded in the inkjet head.

According to an embodiment, the self-sensing circuit part may be embedded in the inkjet head.

According to an embodiment, the plurality of nozzles included in the inkjet head may be divided into a plurality of nozzle groups. The driver may include a plurality of drivers that drive the plurality of nozzle groups, respectively. The impedance converter may include a plurality of impedance converters located between the plurality of nozzle groups and the plurality of drivers, respectively. The self-sensing circuit part may extract, in case that one of a plurality of nozzles included in a first nozzle group and a second nozzle group is driven, a self-sensing voltage for the nozzle driven by differentially amplifying a self-sensing signal of the first nozzle group and a self-sensing signal of the second nozzle group.

According to an embodiment, the self-sensing circuit part may extract a self-sensing voltage for each nozzle based on a difference between an output voltage signal of the impedance converter and an input voltage signal of the impedance converter.

According to an embodiment, the inkjet printing system may further include a reference voltage generator which includes an equivalent impedance converter equal to the impedance converter, and an equivalent capacitor having a capacitance equal to one of the plurality of nozzles. The self-sensing circuit part may extract a self-sensing voltage for each nozzle by subtracting an output voltage signal of the reference voltage generator from an output voltage signal of the impedance converter.

According to an embodiment, the driver may output a voltage increased by an amount equal to a voltage drop caused by the impedance converter as a driving voltage.

According to an embodiment, a maximum allowable current of the impedance converter may be greater than a total current in case that all of the nozzles driven by the driver are activated.

According to an embodiment, the inkjet printing system may further include a control device that controls driving of the driver, and determines whether each nozzle is abnormal by comparing a waveform of the self-sensing voltage of each nozzle measured by the self-sensing circuit part with a pre-stored reference waveform.

According to an embodiment, each of the plurality of nozzles may include: a switch having one terminal connected to the impedance converter and turned on or off based on a control signal; and a piezo element having one terminal connected to another terminal of the switch and another terminal connected to ground, the piezo element generating a pressure wave to eject ink.

According to another embodiment, wherein the self-sensing circuit part monitors a state of each nozzle by comparing a waveform of the measured self-sensing voltage of each nozzle with a pre-stored reference waveform.

According to an embodiment, a method of monitoring nozzle states of an inkjet printing system, the system including: an impedance converter located between an inkjet head including a plurality of nozzles and a driver that controls driving of the plurality of nozzles, the impedance converter having an impedance which varies based on a magnitude of an input voltage of the impedance converter provided by the driver; and a self-sensing circuit part connected to an input terminal of the inkjet head and an output terminal of the impedance converter, the method may comprise measuring a self-sensing voltage of one of the plurality of nozzles using the self-sensing circuit part; comparing a waveform of the measured self-sensing voltage with a pre-stored reference waveform to obtain a comparison result; and determining whether the nozzle is abnormal based on the comparison result.

According to an embodiment, an electronic device may comprise a display device manufactured using the inkjet printing system.

### BRIEF DESCRIPTION OF THE DRAWINGS

The above and other objects, features, and other advantages of embodiments will be more clearly understood from the following description taken in conjunction with the accompanying drawings, in which:

FIG. 1 is a schematic view illustrating an inkjet printing system according to an embodiment;

FIG. 2A is a schematic block diagram illustrating the configuration of the inkjet printing system according to an embodiment;

FIG. 2B is a schematic view illustrating components of the inkjet printing system according to an embodiment;

FIG. 2C is a schematic view illustrating components of the inkjet printing system according to an embodiment;

FIG. 3A is a schematic view illustrating input and output voltages of an impedance converter according to an embodiment;

FIG. 3B is a schematic view illustrating the configuration of a self-sensing circuit part according to an embodiment;

FIG. 4 is a schematic block diagram illustrating the configuration of an inkjet printing system according to another embodiment;

FIG. 5A is a schematic view illustrating the configuration of an inkjet printing system according to another embodiment;

FIG. 5B is a schematic view illustrating components of the inkjet printing system according to another embodiment;

FIG. 5C is a schematic view illustrating components of the inkjet printing system according to another embodiment;

FIG. 6A is a schematic block diagram illustrating the configuration of an inkjet printing system according to another embodiment;

FIG. 6B is a schematic view illustrating components of the inkjet printing system according to another embodiment;

FIG. 6C is a schematic view illustrating components of the inkjet printing system according to another embodiment;

FIG. 7A is a schematic block diagram illustrating the configuration of an inkjet printing system according to another embodiment;

FIG. 7B is a schematic view illustrating components of the inkjet printing system according to another embodiment;

FIG. 7C is a schematic view illustrating components of the inkjet printing system according to another embodiment;

FIG. 8A is a schematic block diagram illustrating the configuration of an inkjet printing system according to another embodiment;

FIG. 8B is a schematic view illustrating components of the inkjet printing system according to another embodiment;

FIG. 8C is a schematic view illustrating components of the inkjet printing system according to another embodiment;

FIG. 9 is a schematic view illustrating the configuration of an inkjet printing system according to another embodiment;

FIG. 10A is a schematic view illustrating the configuration of an inkjet printing system according to another embodiment;

FIG. 10B is a schematic view illustrating the configuration of an inkjet printing system according to another embodiment;

FIG. 11A is a schematic view illustrating the configuration of an inkjet printing system according to another embodiment;

FIG. 11B is a schematic view illustrating the configuration of an inkjet printing system according to another embodiment;

FIG. 12 is a schematic view illustrating voltage waveforms of the inkjet printing system according to the embodiment shown in FIGS. 11A and 11B;

FIG. 13A is a schematic view illustrating an example of preventing a decrease in ejection speed by compensating a driving voltage of the inkjet printing system according to an embodiment;

FIG. 13B is a schematic view illustrating changes in ejection speed depending on the number of driven nozzles of the inkjet printing system according to an embodiment;

FIG. 14A is a schematic view illustrating an impedance converter using a class AB amplifier and a characteristic graph thereof according to an embodiment;

FIG. 14B is a schematic view illustrating an impedance converter using a class AB amplifier and a characteristic graph thereof according to another embodiment;

FIG. 15 is a schematic flowchart illustrating a method of monitoring nozzle states of an inkjet printing system according to an embodiment; and

FIG. 16 is a block diagram of an electronic device according to an embodiment.

FIG. 17 is a schematic diagram of an electronic device according to various embodiments.

### DETAILED DESCRIPTION OF THE EMBODIMENTS

The disclosure will now be described more fully hereinafter with reference to the accompanying drawings, in which embodiments are shown. This disclosure may, however, be embodied in different forms and should not be construed as limited to the embodiments set forth herein. Rather, these embodiments are provided so that this disclosure will be thorough and complete, and will fully convey the scope of the disclosure to those skilled in the art. Various embodiments do not have to be exclusive nor limit the disclosure. For example, specific shapes, configurations, and characteristics of an embodiment may be used or implemented in another embodiment.

In the drawings, sizes, thicknesses, ratios, and dimensions of the elements may be exaggerated for ease of description and for clarity. Like reference numbers and/or reference characters refer to like elements throughout.

In the specification and the claims, the term “and/or” is intended to include any combination of the terms “and” and “or” for the purpose of its meaning and interpretation. For example, “A and/or B” may be understood to mean “A, B, or A and B.” The terms “and” and “or” may be used in the conjunctive or disjunctive sense and may be understood to be equivalent to “and/or.”

In the specification and the claims, the phrase “at least one of” is intended to include the meaning of “at least one selected from the group of” for the purpose of its meaning and interpretation. For example, “at least one of A and B” may be understood to mean “A, B, or A and B.”

It will be understood that, although the terms “first,” “second,” etc. may be used herein to describe various elements, these elements should not be limited by these terms. These terms are only used to distinguish one element from another. For example, a first element may be referred to as a second element, and similarly, a second element may be referred to as a first element without departing from the scope of the disclosure.

As used herein, the singular forms “a,” “an,” and “the” are intended to include the plural forms as well, unless the context clearly indicates otherwise.

The terms “comprises,” “comprising,” “includes,” and/or “including,”, “has,” “have,” and/or “having,” and variations thereof when used in this specification, specify the presence of stated features, integers, steps, operations, elements, components, and/or groups thereof, but do not preclude the presence or addition of one or more other features, integers, steps, operations, elements, components, and/or groups thereof.

It will be understood that when an element (or a layer, a region, a portion, or the like) is referred to as “formed on,” “being on,” “disposed on,” “connected to,” or “coupled to” another element in the specification, it can be directly formed on, disposed on, connected or coupled to another element mentioned above, or intervening elements may be disposed therebetween. It will be understood that the terms “connected to” or “coupled to” may include a physical or electrical connection or coupling.

The spatially relative terms “below,” “beneath,” “lower,” “above,” “upper,” or the like, may be used herein for ease of description to describe the relations between one element or component and another element or component as illustrated in the drawings. It will be understood that the spatially relative terms are intended to encompass different orientations of the device in use or operation, in addition to the orientation depicted in the drawings. For example, in the case where a device illustrated in the drawing is turned over, the device positioned “below” or “beneath” another device may be placed “above” another device. Accordingly, the illustrative term “below” may include both the lower and upper positions. The device may also be oriented in other directions and thus the spatially relative terms may be interpreted differently depending on the orientations.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within +30%, 20%, 10%, 5% of the stated value.

Unless otherwise defined or implied herein, all terms (including technical and scientific terms) used herein have the same meaning as commonly understood by one of ordinary skill in the art to which the disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Embodiments may be described and illustrated in the accompanying drawings in terms of functional blocks, units, and/or modules.

Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies.

In the case of the blocks, units, and/or modules being implemented by microprocessors or other similar hardware, they may be programmed and controlled using software (for example, microcode) to perform various functions discussed herein and may optionally be driven by firmware and/or software.

It is also contemplated that each block, unit, and/or module may be implemented by dedicated hardware, or as a combination of dedicated hardware to perform some functions and a processor (for example, one or more programmed microprocessors and associated circuitry) to perform other functions.

Each block, unit, and/or module of embodiments may be physically separated into two or more interacting and discrete blocks, units, and/or modules without departing from the scope of the disclosure.

Further, the blocks, units, and/or modules of embodiments may be physically combined into more complex blocks, units, and/or modules without departing from the scope of the disclosure.

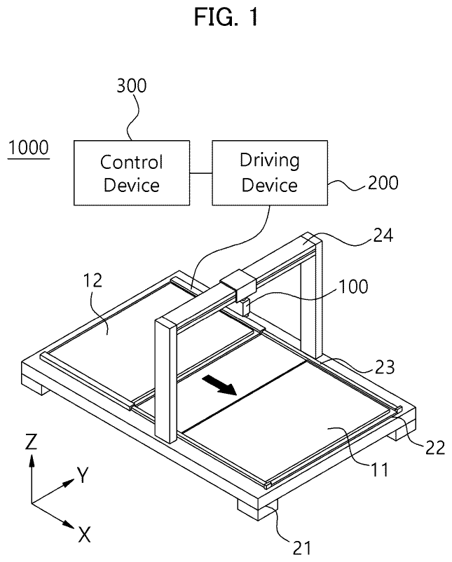

FIG. 1 is a schematic view illustrating an inkjet printing system according to an embodiment.

The phrase “in a plan view” means viewing the object from the top, and the phrase “in a schematic cross-sectional view” means viewing a cross-section of which the object is vertically cut from the side. Hence, the expression “in a plan view” used herein may mean that an object is viewed in the third direction (e.g. Z-axis direction) from the top. The phrase “in a schematic cross-sectional view” means viewing a cross-section in the first direction (e.g. X-axis direction) or the second direction (e.g. Y-axis direction) of which the object is vertically cut from the side. The third direction also can be referred to as a “thickness direction.”

Referring to FIG. 1, an inkjet printing system 1000 according to an embodiment may eject ink (e.g., materials such as organic materials or metallic materials) onto target substrates 11 and 12 (e.g., display panels or display devices). For example, the inkjet printing system 1000 may perform a printing process by moving the target substrates 11 and 12 in a first direction (e.g., an x-axis direction) using a transport means 23 for transporting a carrier 22, which is movably coupled to a support plate 21 and on which the target substrates 11 and 12 are mounted, and sequentially or in parallel (or simultaneously) ejecting the ink onto the target substrates 11 and 12 in a specific amount and/or in a specific pattern through an inkjet head 100. As another example, the inkjet printing system 1000 may perform the printing process by moving the inkjet head (e.g., nozzles) 100, which is movably connected to a head connection bar 24, and ejecting the ink onto the target substrates 11 and 12. The inkjet printing system 1000 may perform a monitoring process for monitoring (or inspecting) the state of each component (e.g., nozzle) of the inkjet printing system 1000. The inkjet printing system 1000 may be used in some processes during the manufacturing of a display. The display that can be manufactured using the inkjet printing system 1000 may include, for example, a liquid crystal display, an organic light emitting display, and an inorganic light emitting display, etc. However, it is not limited thereto.

According to an embodiment, the inkjet printing system 1000 may include a driving device 200 that drives each component of the inkjet head 100 (e.g., ejects ink from each nozzle) and monitors the state of each component, and a control device 300 that controls the driving device 200. The driving device 200 may include various configurations, components, and/or structures. The driving device 200 and the control device 300 will be described in detail below. Although not shown in the drawings, the inkjet printing system 1000 may further include sensors capable of measuring an amount of ink, sensors capable of controlling pressure, speed, and concentration of ink ejection, and valves capable of controlling ink flow, etc. Although not shown in the drawings, according to an embodiment, the inkjet printing system 1000 may further include a tank for handling various fluids (e.g., resin, nitrogen (N₂), or clean dry air (CDA), etc.) where the fluids are flowed-in, stored, and flowed-out, as well as a pressure control module for controlling a pressure of the fluid in the tank.

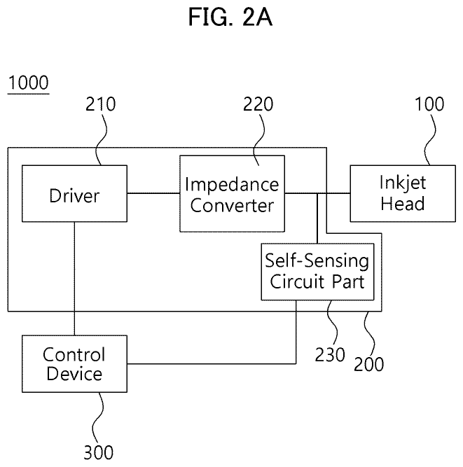

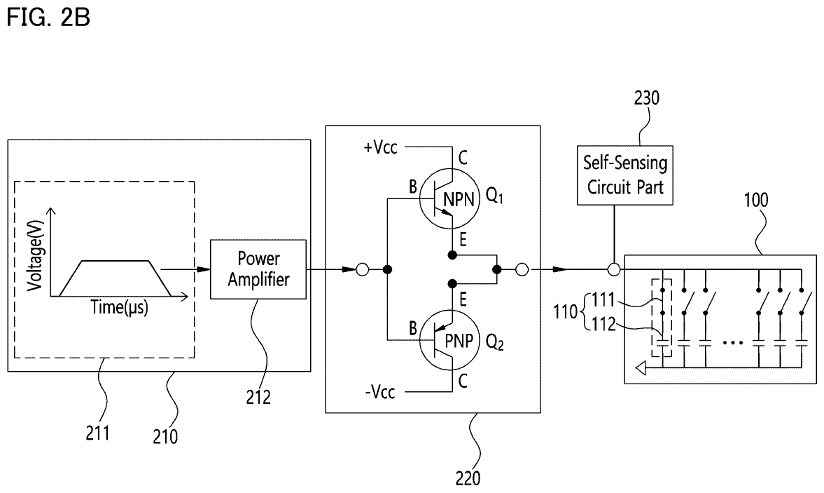

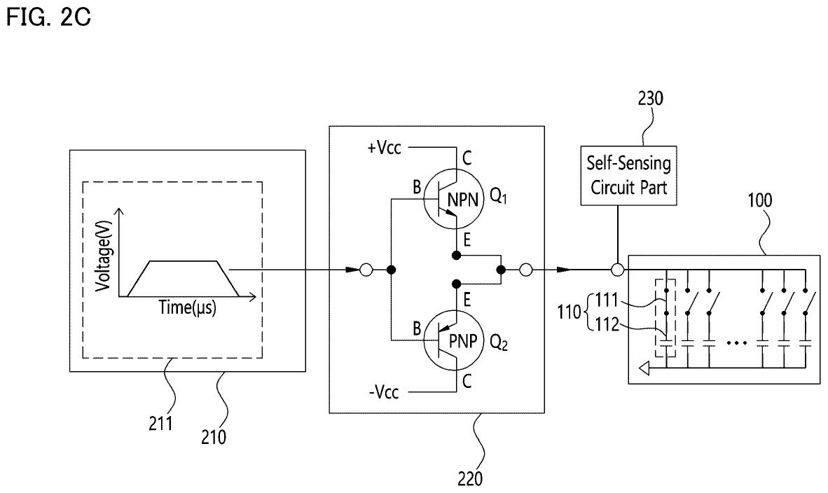

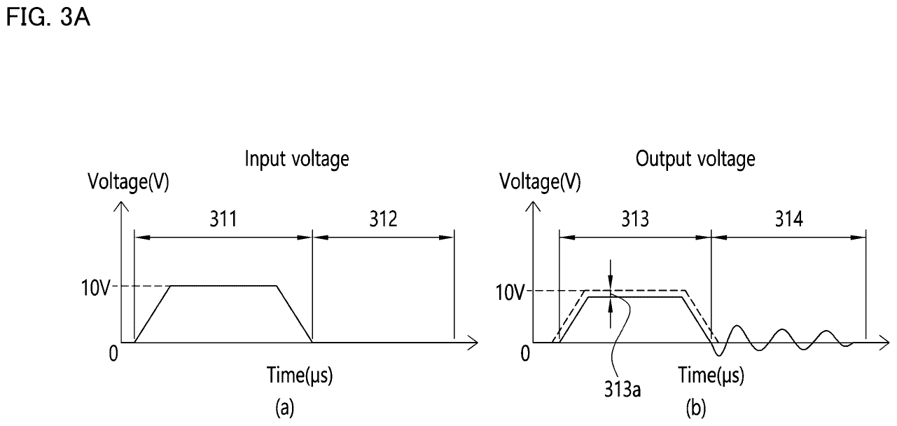

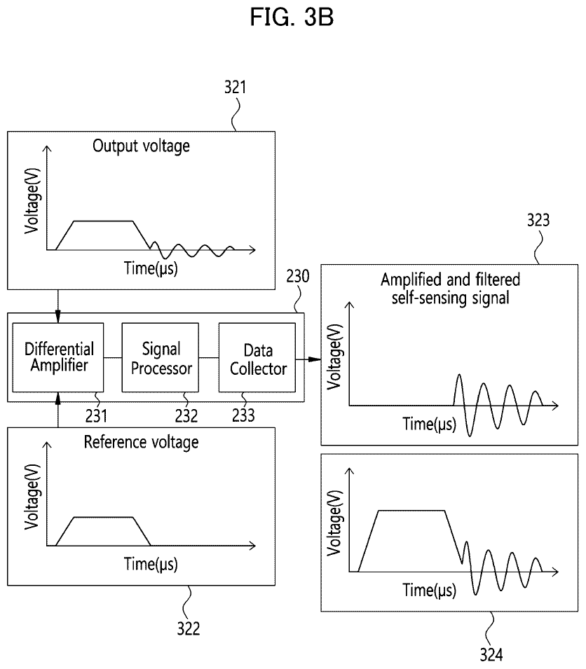

FIG. 2A is a schematic block diagram illustrating the configuration of the inkjet printing system according to an embodiment, FIG. 2B is a schematic view illustrating components of the inkjet printing system according to an embodiment, FIG. 2C is a schematic view illustrating components of the inkjet printing system according to an embodiment, FIG. 3A is a schematic view illustrating input and output voltages of an impedance converter according to an embodiment, and FIG. 3B is a schematic view illustrating the configuration of a self-sensing circuit part according to an embodiment.

Referring to FIGS. 2A to 3B, the inkjet printing system 1000 according to an embodiment may include the inkjet head 100, the driving device 200, and the control device 300.

The inkjet head 100 may include multiple nozzles 110 for ejecting ink droplets (hereinafter, also referred to as ink), as shown in FIGS. 2B and 2C.

One terminal of each nozzle 110 may be electrically connected to an input terminal of the inkjet head 100 (or an output terminal of the driving device 200), and another terminal thereof may be electrically connected to a ground (or a configuration equivalent to the ground).

Each nozzle 110 may include a switch 111 and a piezo element 112. The switch 111 may control an electrical connection between the piezo element 112 and the input terminal of the inkjet head 100 (e.g., turn the connection on (or close) or off (or open)). For example, the switching of the switch 111 may be controlled by a separate switch control unit (not illustrated). In case where the state of the nozzle 110 is being monitored, the inkjet printing system 1000 may turn on the switch associated with the nozzle being monitored, as shown in FIGS. 2B and 2C, while turning off the switches of the remaining nozzles. By repeating the above-described process, the inkjet printing system 1000 may sequentially check the states of nozzles included in the inkjet head 100 one by one. This sequential process is necessary because, in case where the switches of multiple nozzles are turned on simultaneously, the self-sensing signals of the nozzles are measured together, making it impossible to identify (or recognize) which nozzle is malfunctioning.

The piezo element 112 may include a piezoelectric material. For example, in case where the driving voltage from the driver 210 is applied (or transmitting), the piezo element 112 may generate a pressure wave to eject ink droplets from the corresponding nozzle. A residual pressure wave may remain (or persist) for a while after the ink ejection (or jetting) is complete, producing a vibration signal from the piezo element 112. Due to these characteristics, the piezo element 112 may function as a sensor although it is an actuator. The piezo element 112 may also be represented as a capacitor, as shown in FIGS. 2B and 2C, because its electrical characteristics are similar to those of a capacitor in a circuit.

The driving device 200 may control driving of the nozzles of the inkjet head 100 and monitor the nozzle states. To this end, the driving device 200 may include a driver 210, an impedance converter 220, and a self-sensing circuit part 230.

The driver 210 may control the driving of the nozzle 110 of the inkjet head 100 to eject the ink. The output of the driver 210 may be provided (or transmitted) to the inkjet head 100 via the impedance converter 220. In embodiments, the output (e.g., a driving power) of the driver 210 may also be provided (or input) to the self-sensing circuit part 230 (e.g., a differential amplifier 231) and used as a reference voltage to remove the driving voltage from a voltage signal at an output terminal of the impedance converter 220 (or the input terminal of the inkjet head 100).

According to an embodiment, the driver 210 may include a driving signal generator 211 that generates a driving signal with a designated waveform for driving the nozzle 110 and a power amplifier 212 that amplifies the generated driving signal to generate a driving power (e.g., the driving voltage), as shown in FIG. 2B.

According to another embodiment, the driver 210 may include only a driving signal generator 211 that generates a driving signal with a designated waveform for driving the nozzle 110, as shown in FIG. 2C. The impedance converter 220 of FIG. 2C may perform the function of the power amplifier 212 of FIG. 2B. In case where the multiple nozzles of the inkjet head 100 can be adequately driven by the power amplified by the impedance converter 220 (e.g., a class B amplifier), the embodiment of FIG. 2C may simplify the structure of the inkjet printing system 1000 (e.g., the driver 210) by omitting the power amplifier 212 from the driver 210.

The impedance converter 220 may be located between the driver 210 and the inkjet head 100 and has an output impedance which can vary based on a magnitude of an input voltage of the impedance converter 220 provided by the driver 210 (or an output voltage of the driver 210). For example, the impedance converter 220 may have (or exhibit) a very high impedance (e.g., an impedance exceeding a reference value) in case where the input voltage of the impedance converter 220 (or the output voltage of the driver 210) is within a designated range (e.g., about −0.7 V (voltage) to about 0.7 V) (or is close to (or approaches) zero after driving the inkjet head 100). The impedance converter 220 may have a very low impedance in case where the input voltage of the impedance converter 220 (or the output voltage of the driver 210) is outside the designated range (e.g., about −0.7 V to about 0.7 V) (or falls within a voltage range used for driving the inkjet head 100 (e.g., a jetting voltage range exceeding positive dozens of volts or less than negative dozens of volts)).

According to an embodiment, the impedance converter 220 may include a class B amplifier having a complementary push-pull structure, as shown in FIGS. 2B and 2C. Specifically, the class B amplifier having the complementary push-pull structure may include an NPN type bipolar junction transistor (BJT) Q1 and a PNP type BJT Q2, which are complementarily coupled with each other. A positive voltage +Vcc is applied to a collector C of the NPN type BJT Q1, a negative voltage-Vcc is applied to a collector C of the PNP type BJT Q2, the driving voltage is applied to bases B of the NPN type BJT Q1 and the PNP type BJT Q2, and emitters E of the NPN type BJT Q1 and the PNP type BJT Q2 may be connected to the inkjet head 100.

The impedance converter 220 has the very low impedance while a driving voltage of several tens of volts (V) (e.g., about 10 V) is applied via the driver 210, as shown by reference numeral 311 in FIG. 3A. As shown by reference numeral 313 in FIG. 3A, the output voltage of the impedance converter 220 may decrease by a selected magnitude 313a (e.g., a threshold voltage (e.g., about 0.7 V)) due to the characteristics of the BJT included in the impedance converter 220. As shown by reference numeral 312 in FIG. 3A, the impedance converter 220 may have the very high impedance during periods (or sections) where a voltage of the designated range (e.g., “0 V”) is input (or applied). No voltage is output from the impedance converter 220, but as shown by reference numeral 314 in FIG. 3A, the self-sensing voltage of the piezo element 112 (whose switch is turned on) may be detected as the output voltage of the impedance converter 220. The self-sensing voltage may be input to the self-sensing circuit part 230. Through this process, the impedance converter 220 enables the system to perform efficient self-sensing of each nozzle 110 in the inkjet head 100 without affecting its ejection performance (or jetting performance). For example, the impedance converter 220 may optimize an actuator function of the piezo element 112 for ejecting ink and a sensor function for monitoring the state of the nozzle.

The self-sensing circuit part 230 may be connected to the input terminal of the inkjet head 100. The self-sensing circuit part 230 may measure a self-sensing voltage of one of the nozzles 110 (e.g., a nozzle with its switch turned on) and process the measured self-sensing voltage to determine the state of the nozzle (e.g., for differential amplification, filtering, improving signal-to-noise ratio, and the like). For example, as shown in FIG. 3B, the self-sensing circuit part 230 may include the differential amplifier 231, a signal processor 232, and a data collector 233. The differential amplifier 231 may extract only the self-sensing voltage signal by removing the driving voltage from an output voltage signal 321 of the impedance converter 220. For example, the differential amplifier 231 may extract only the self-sensing voltage signal by receiving the output voltage signal 321 and a reference signal 322 corresponding to the driving voltage and removing unwanted driving voltage effect from the output voltage signal 321. The signal processor 232 may amplify and filter the extracted self-sensing voltage signal. The signal processor 232 may process (or adjust) the amplified and filtered signal 323 to have a voltage in a designated range (e.g., a voltage in a range supported by the data collector 233). The data collector 233 may collect and store the amplified and filtered signals 323 for each nozzle. The data collector 233 may convert the amplified and filtered signal 323 into a digital signal for further analysis.

In case where the output voltage signal 321 is amplified without removing the driving voltage from the output voltage signal 321, as shown by reference numeral 324, the driving signal may also be amplified, thereby causing a saturation problem in the signal processor 232 (e.g., an amplifier included in the signal processor 232). This may reduce the signal-to-noise ratio of the self-sensing signal. However, the self-sensing circuit part 230 may remove the driving voltage having a large magnitude, as shown by reference numeral 323, and amplifies only the self-sensing signal having a small magnitude (e.g., about 0.1 V or less). This may prevent the saturation problem in the signal processor 232 and improve the signal-to-noise ratio of the self-sensing signal. This approach may enable more accurate determination of the states of the nozzles.

According to embodiments, positions of the differential amplifier 231 and the signal processor 232 in the self-sensing circuit part 230 may be changed or rearranged. According to other embodiments, the signal processor 232 and/or the data collector 233 may be omitted from the self-sensing circuit part 230.

The control device 300 may control the operation of the driver 210. The control device 300 may monitor the state of the nozzle 110. For example, the control device 300 may receive the self-sensing voltage of each nozzle measured by the self-sensing circuit part 230 and compare the waveforms (or patterns) of the received self-sensing voltages with a pre-stored reference waveform to obtain the comparison result and to determine whether each nozzle is functioning abnormally. According to embodiments, the self-sensing circuit part 230 may also perform the determination of nozzle abnormalities.

As described above, the inkjet printing system 1000 according to an embodiment may solve the conventional trade-off issue between the driving voltage and the self-sensing voltage. This may be achieved by including an impedance converter 220, located between the inkjet head 100 and the driver 210, which varies its output impedance based on the magnitude of the input voltage.

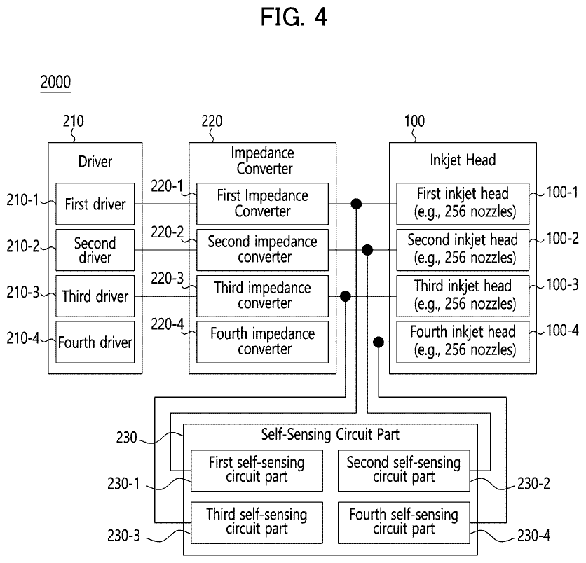

FIG. 4 is a schematic block diagram illustrating the configuration of an inkjet printing system according to another embodiment.

Referring to FIG. 4, an inkjet printing system 2000 according to another embodiment may support parallel driving. For example, unlike the previous embodiments in which multiple nozzles 110 are driven by one driver 210 and one impedance converter 220, and the states of the plurality of nozzles 110 are monitored one by one through one self-sensing circuit part 230, the inkjet printing system 2000 of FIG. 4 may support parallel printing. To this end, a driver 210 may include multiple drivers 210-1, 210-2, 210-3, and 210-4, an impedance converter 220 may include multiple impedance converters 220-1, 220-2, 220-3, and 220-4, the self-sensing circuit part 230 may include multiple self-sensing circuit parts 230-1, 230-2, 230-3, and 230-4, and an inkjet head 100 may include multiple nozzle groups 100-1, 100-2, 100-3, and 100-4. For example, in case where the inkjet printing system 2000 includes a total of N nozzles (e.g., “1024”) and a total of M nozzle groups (e.g., “4”), each nozzle group may include “N/M” nozzles (e.g., “256=1024/4”), respectively. The inkjet printing system 2000 may drive multiple nozzles included in a first nozzle group 100-1 using a first driver 210-1 and a first impedance converter 220-1 and monitor the states of the multiple nozzles included in the first nozzle group 100-1 through a first self-sensing circuit part 230-1. The inkjet printing system 2000 may drive the nozzles included in a second nozzle group 100-2 using a second driver 210-2 and a second impedance converter 220-2 and monitor the states of the nozzles included in the second nozzle group 100-2 through a second self-sensing circuit part 230-2. The inkjet printing system 2000 may drive the nozzles included in a third nozzle group 100-3 using a third driver 210-3 and a third impedance converter 220-3 and monitor the states of the nozzles included in the third nozzle group 100-3 through a third self-sensing circuit part 230-3. The inkjet printing system 2000 may drive the nozzles included in a fourth nozzle group 100-4 using a fourth driver 210-4 and a fourth impedance converter 220-4 and monitor the states of the nozzles included in the fourth nozzle group 100-4 through a fourth self-sensing circuit part 230-4.

According to embodiment, an inkjet printing system 2000 may include multiple inkjet heads. Each of the inkjet heads may correspond to the inkjet head 100.

The inkjet printing system 2000 of FIG. 4 may improve productivity (e.g., sensing speed) by enabling parallel sensing. This system may simultaneously monitor the nozzle states of the inkjet heads connected in parallel. For example, assuming the total number of nozzles is the same, the inkjet printing system 2000 of FIG. 4 may reduce the total monitoring time for all nozzles to about “one-fourth (¼)” compared to a system that performs sequential monitoring without parallel sensing.

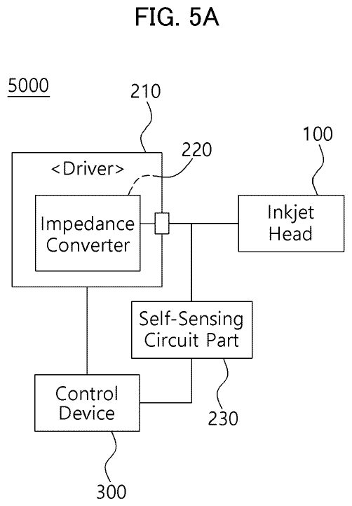

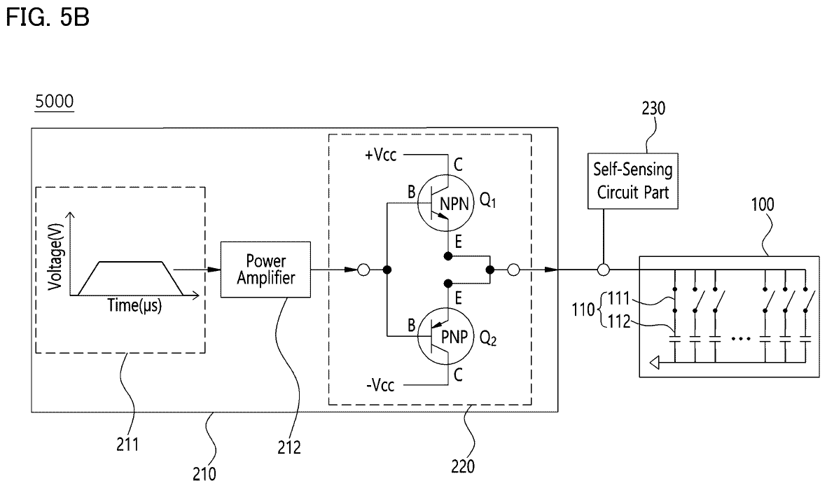

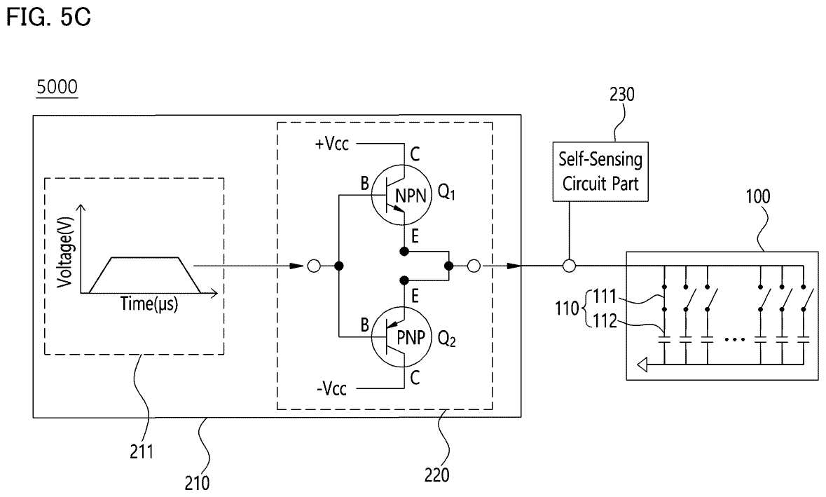

FIG. 5A is a schematic view illustrating the configuration of an inkjet printing system according to another embodiment, FIG. 5B is a schematic view illustrating components of the inkjet printing system according to another embodiment, and FIG. 5C is a schematic view illustrating components of the inkjet printing system according to another embodiment.

Referring to FIGS. 5A to 5C, an inkjet printing system 5000 according to another embodiment may include an impedance converter 220 embedded in a driver 210 (e.g., the impedance converter 220 and the driver 210 may be integrated into a single integrated circuit (IC)). In an embodiment, the driver 210 may include a driving signal generator 211, a power amplifier 212, and an impedance converter 220, as shown in FIG. 5B.

According to another embodiment, the driver 210 may include the driving signal generator 211 and the impedance converter 220, as shown in FIG. 5C. The impedance converter 220 of FIG. 5C may also perform the function of the power amplifier 212 of FIG. 5B.

Except for the differences described above, the inkjet printing system 5000 is similar to the inkjet printing system 1000 described in an earlier embodiment. Therefore, other components will not be described in detail.

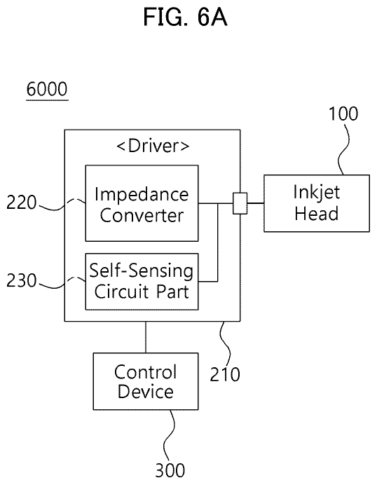

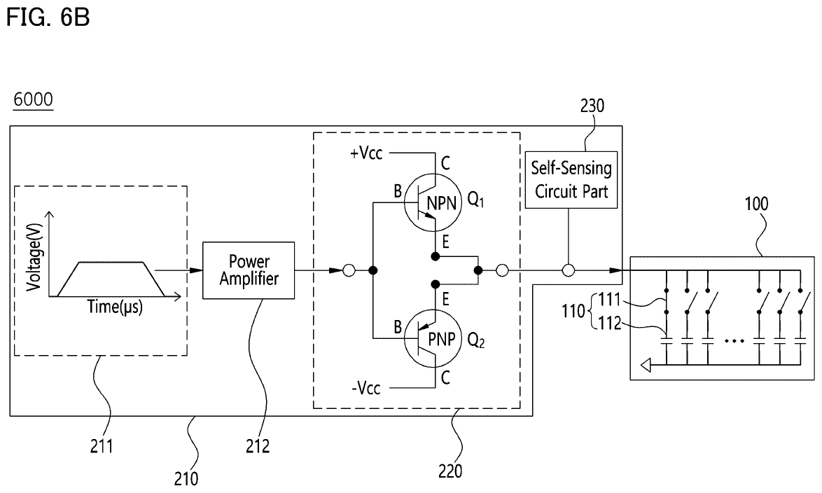

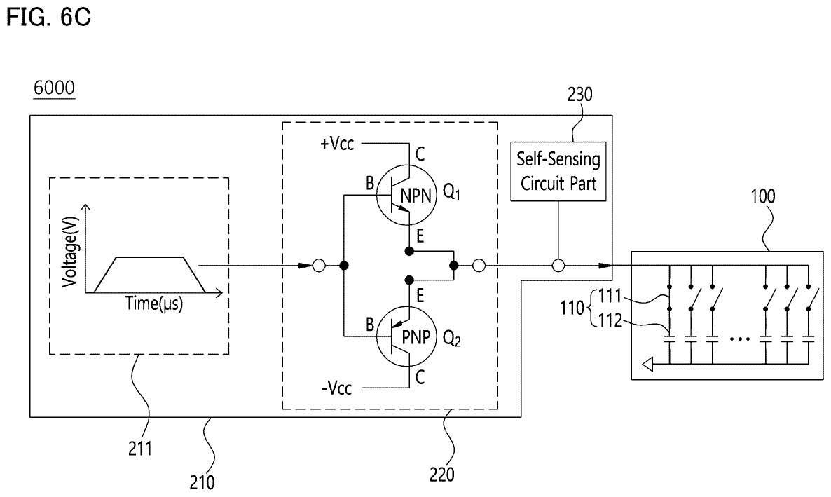

FIG. 6A is a schematic block diagram illustrating the configuration of an inkjet printing system according to another embodiment, FIG. 6B is a schematic view illustrating components of the inkjet printing system according to another embodiment, and FIG. 6C is a schematic view illustrating components of the inkjet printing system according to another embodiment.

Referring to FIGS. 6A to 6C, an inkjet printing system 6000 according to another embodiment may include an impedance converter 220 and a self-sensing circuit part 230 embedded in a driver 210. In an embodiment, the driver 210 may include a driving signal generator 211, a power amplifier 212, the impedance converter 220, and the self-sensing circuit part 230, as shown in FIG. 6B.

According to another embodiment, the driver 210 may include the driving signal generator 211, the impedance converter 220, and the self-sensing circuit part 230, as shown in FIG. 6C. The impedance converter 220 of FIG. 6C may also perform the function of the power amplifier 212 of FIG. 6B.

Except for the differences described above, the inkjet printing system 6000 is similar to the inkjet printing system 1000 described in an earlier embodiment. Therefore, other components will not be described in detail.

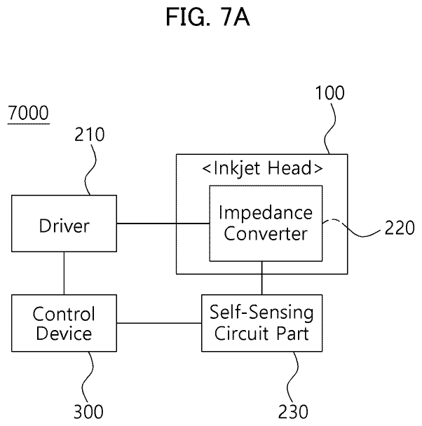

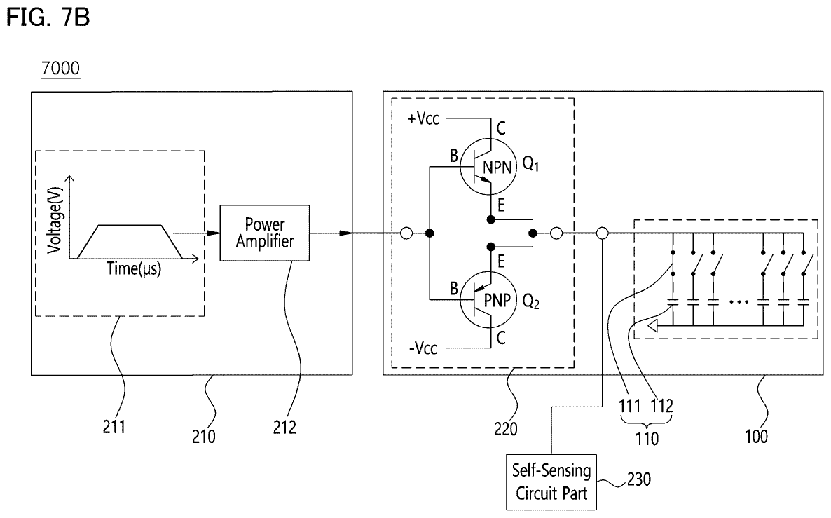

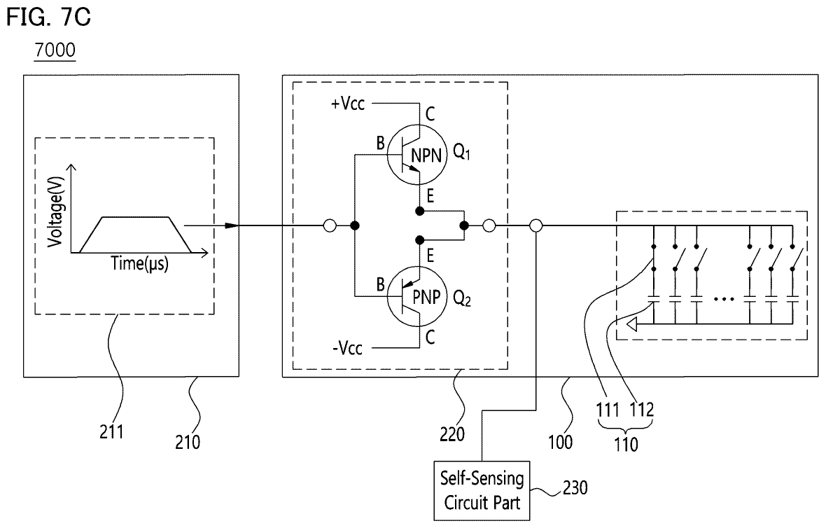

FIG. 7A is a schematic block diagram illustrating the configuration of an inkjet printing system according to another embodiment, FIG. 7B is a schematic view illustrating components of the inkjet printing system according to another embodiment, and FIG. 7C is a schematic view illustrating components of the inkjet printing system according to another embodiment.

Referring to FIGS. 7A to 7C, an inkjet printing system 7000 according to another embodiment may include an impedance converter 220 embedded in an inkjet head 100. In an embodiment, a driver 210 may include a driving signal generator 211 and a power amplifier 212, as shown in FIG. 7B. In another embodiment, the driver 210 may include only the driving signal generator 211, as shown in FIG. 7C. The impedance converter 220 of FIG. 7C may perform the function of the power amplifier 212 in FIG. 7B.

Except for the differences described above, the inkjet printing system 7000 is similar to the inkjet printing system 1000 described in an earlier embodiment. Therefore, other components will not be described in detail.

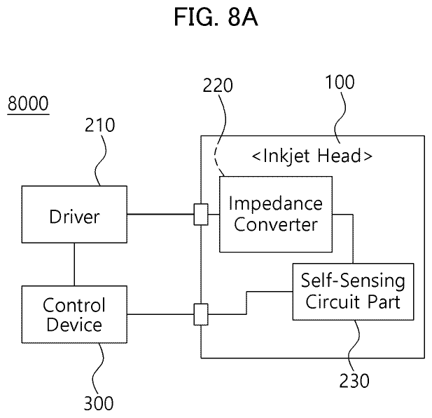

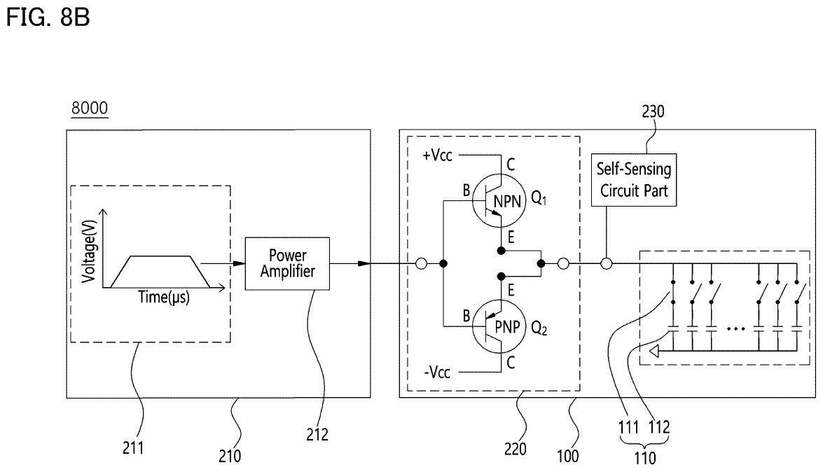

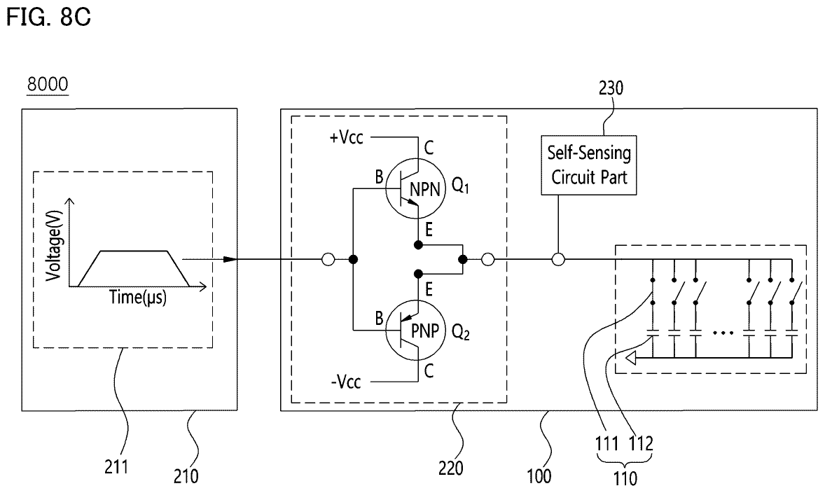

FIG. 8A is a schematic block diagram illustrating the configuration of an inkjet printing system according to another embodiment, FIG. 8B is a schematic view illustrating components of the inkjet printing system according to another embodiment, and FIG. 8C is a schematic view illustrating components of the inkjet printing system according to another embodiment.

Referring to FIGS. 8A to 8C, an inkjet printing system 8000 according to another embodiment may include an impedance converter 220 and a self-sensing circuit part 230 embedded in an inkjet head 100. In an embodiment, a driver 210 may include a driving signal generator 211 and a power amplifier 212, as shown in FIG. 8B. In another embodiment, the driver 210 may include only the driving signal generator 211, as shown in FIG. 8C. The impedance converter 220 of FIG. 8C may perform the function of the power amplifier 212 in FIG. 8B.

Except for the differences described above, the inkjet printing system 8000 is similar to the inkjet printing system 1000 described in an earlier embodiment. Therefore, other components will not be described in detail.

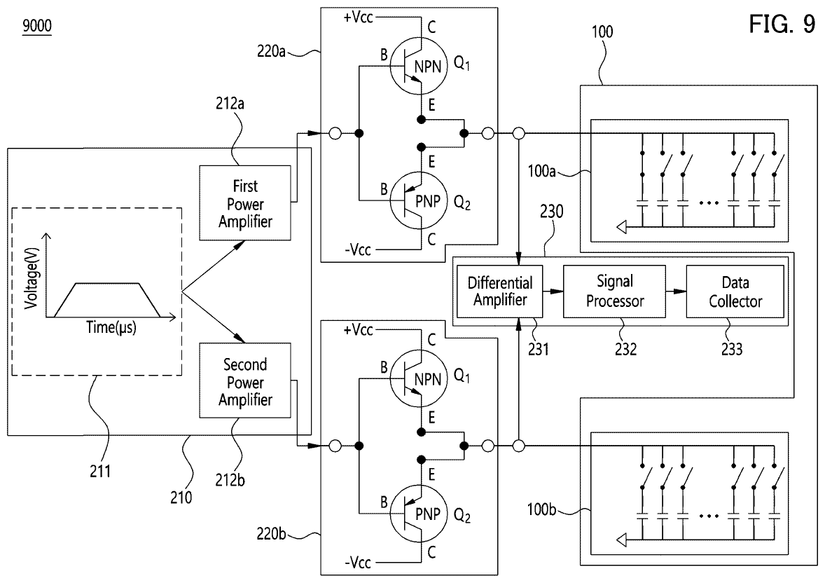

The above descriptions outline various embodiments based on the connection and arrangement relationships between the respective components of the inkjet printing system, as shown in FIGS. 2A to 8C. Hereinafter, various embodiments for providing a reference voltage to the differential amplifier 231 will be described with reference to FIGS. 9 to 12.

FIG. 9 is a schematic view illustrating the configuration of an inkjet printing system according to another embodiment.

Referring to FIG. 9, multiple nozzles included in an inkjet head 100 of an inkjet printing system 9000 according to another embodiment may be divided into an even number of groups (hereinafter referred to as nozzle groups). For example, the nozzles may be divided into a first nozzle group 100a and a second nozzle group 100b, but it is not limited thereto.

The driver 210 may include an even number of drivers that drive the even number of nozzle groups, respectively. The even number of drivers may include two drivers which operate as a pair. The two drivers may operate as a pair, with a first driver that drives the first nozzle group 100a and a second driver that drives the second nozzle group 100b. Referring to FIG. 9, the driver 210 may include a driving signal generator 211 and multiple power amplifiers (e.g., a first power amplifier 212a and a second power amplifier 212b). For example, the first driver and the second driver share a single driving signal generator 211. However, this is merely an example, and the first driver and the second driver may include their own driving signal generator, respectively.

The impedance converter 220 may include an even number of impedance converters that are located between the even number of nozzle groups and the even number of drivers, respectively. For example, the impedance converter 220 may include a first impedance converter 220a that is located between the first power amplifier 212a and the first nozzle group 100a, and a second impedance converter 220b that is located between the second power amplifier 212b and the second nozzle group 100b.

A self-sensing circuit part 230 of the inkjet printing system 9000 may measure a self-sensing voltage of a nozzle being driven in the first nozzle group 100a or the second nozzle group 100b based on an output voltage signal of the first impedance converter 220a and an output voltage signal of the second impedance converter 220b. For example, in case where one of the nozzles included in the first nozzle group 100a is being driven and the nozzles included in the second nozzle group 100b are not being driven, the self-sensing circuit part 230 may calculate the difference between the output voltage signal of the first impedance converter 220a and the output voltage signal of the second impedance converter 220b to measure a self-sensing voltage of the nozzle being driven in the first nozzle group 100a. The output voltage signal of the second impedance converter 220b may operate as the reference voltage for the differential amplifier 231. As another example, in case where the nozzles included in the first nozzle group 100a are not being driven and one of the nozzles included in the second nozzle group 100b is being driven, the self-sensing circuit part 230 may calculate the difference between the output voltage signal of the second impedance converter 220b and the output voltage signal of the first impedance converter 220a to measure a self-sensing voltage of the nozzle being driven in the second nozzle group 100b. The output voltage signal of the first impedance converter 220a may operate as the reference voltage for the differential amplifier 231.

FIG. 9 illustrates that the driver 210, the impedance converter 220, and the inkjet head 100 include two drivers, two impedance converters, and two nozzle groups, respectively. However, the driver 210, the impedance converter 220, and the inkjet head 100 may include N drivers, N impedance converters, and N nozzle groups, respectively, where N represents even natural numbers.

The inkjet printing system 9000 shown in FIG. 9 may measure (or extract) the self-sensing voltage without being affected by a voltage reduction caused by the impedance converter. This may be achieved by pairing two impedance converters and using the output of one unit in the paired impedance converters as the reference voltage. The inkjet printing system 9000 in FIG. 9 may minimize the number of self-sensing circuit parts 230 (e.g., reducing it to half (½)), thereby lowering the manufacturing costs.

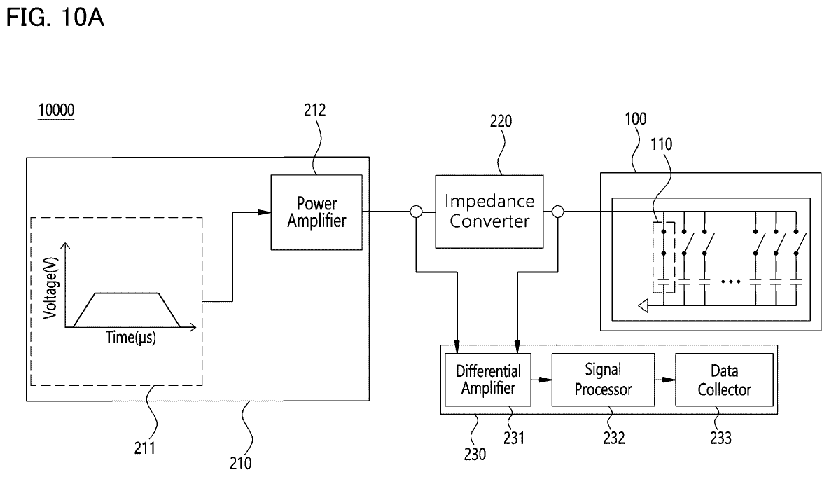

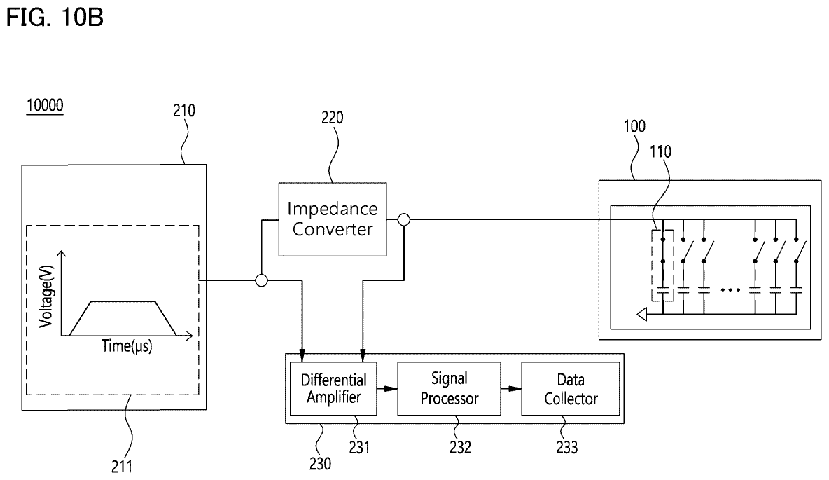

FIG. 10A is a schematic view illustrating the configuration of an inkjet printing system according to another embodiment, and FIG. 10B is a schematic view illustrating the configuration of an inkjet printing system according to another embodiment.

Referring to FIGS. 10A and 10B, the inkjet printing system 10000 according to another embodiment may use an input voltage of an impedance converter 220 as a reference voltage for a differential amplifier 231. Specifically, the differential amplifier 231 may extract a self-sensing signal by comparing a voltage signal at an input terminal of the inkjet head 100 (or an output voltage signal of the impedance converter 220) with an input voltage signal of the impedance converter 220. For example, this may involve calculating a difference between the voltage signal at the input terminal of the inkjet head 100 and the input voltage signal of the impedance converter 220.

FIG. 10A illustrates an example in which the driver 210 includes a driving signal generator 211 and a power amplifier 212, while FIG. 10B illustrates an example in which the driver 210 includes only the driving signal generator 211.

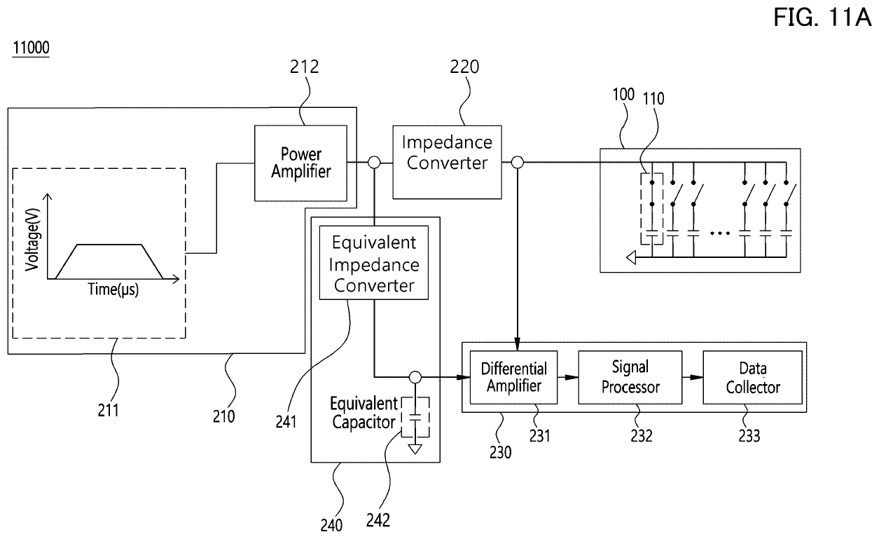

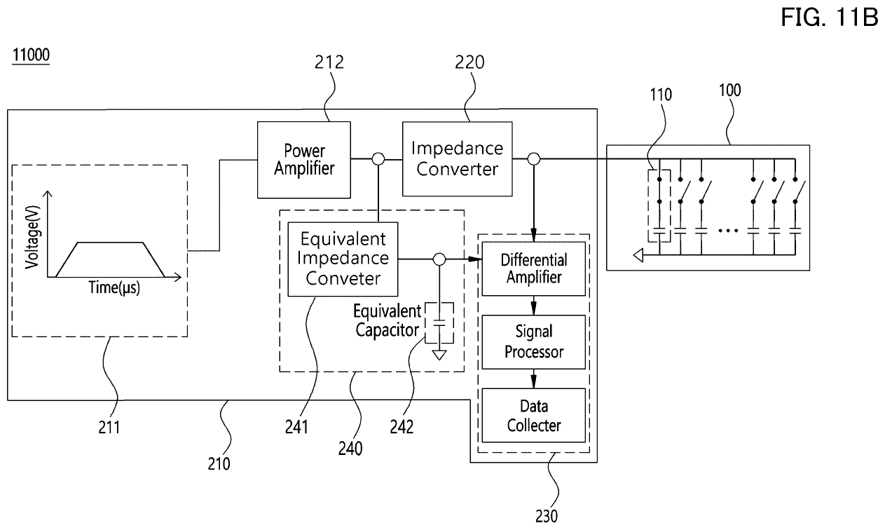

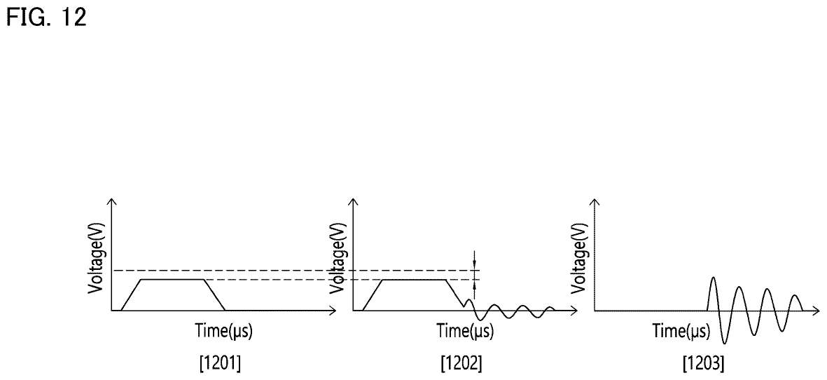

FIG. 11A is a schematic view illustrating the configuration of an inkjet printing system according to another embodiment, FIG. 11B is a schematic view illustrating the configuration of an inkjet printing system according to another embodiment, and FIG. 12 is a schematic view illustrating voltage waveforms of the inkjet printing system according to the embodiment shown in FIGS. 11A and 11B.

Referring to FIGS. 11A to 12, an inkjet printing system 11000 according to another embodiment may further include a reference voltage generator 240 (or also may be referred to as an equivalent circuit) for providing a reference voltage to a differential amplifier 231. The reference voltage generator 240 may include an equivalent impedance converter 241 having the same structure as the impedance converter 220 and an equivalent capacitor 242 having the same or similar capacitance value as one piezo element 112.

The differential amplifier 231 may generate a self-sensing signal 1203 by calculating a difference between a voltage signal 1202 at the input terminal of the inkjet head 100 (or an output voltage signal of the impedance converter 220) and an output signal (hereinafter, referred to as a reference signal) 1201 of the reference voltage generator 240, as shown in FIG. 12. The reference signal 1201 of the reference voltage generator 240 may also experience a voltage drop caused by the equivalent impedance converter 241. For example, the reference signal 1201 of the reference voltage generator 240 may be equivalent to the driving voltage of the voltage signal 1202 at the input terminal of the inkjet head 100.

The inkjet printing system 11000 according to another embodiment described above may provide a reference signal substantially equivalent to the driving voltage to the differential amplifier 231 through the separate reference voltage generator 240, thereby canceling all signals unrelated to the self-sensing signal (e.g., noise occurring in a common mode, voltage drops caused by the impedance converter 220, and signal differences resulting from characteristics of the impedance converter 220). As a result, the inkjet printing system 11000 may measure an improved self-sensing signal and enhance the reliability of nozzle states monitoring results (e.g., defect detection).

FIG. 11A illustrates an example in which the impedance converter 220, the self-sensing circuit part 230, and the reference voltage generator 240 are located outside the driver 210, while FIG. 11B illustrates an example in which the impedance converter 220, the self-sensing circuit part 230, and the reference voltage generator 240 are embedded in the driver 210.

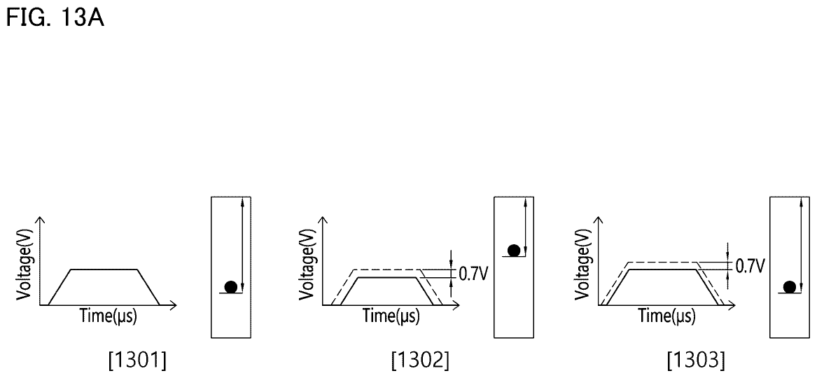

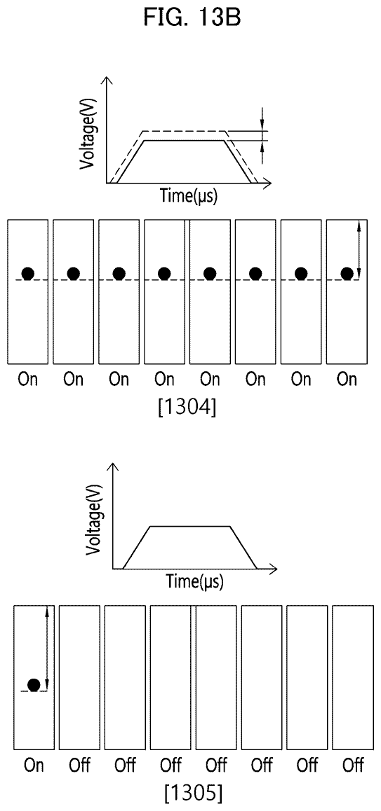

FIG. 13A is a schematic view illustrating an example of preventing a decrease in ejection speed by compensating a driving voltage of the inkjet printing system according to an embodiment, and FIG. 13B is a schematic view illustrating changes in ejection speed based on the number of driven nozzles in the inkjet printing system according to an embodiment.

Referring to FIG. 13A, the inkjet printing system according to an embodiment may prevent a decrease in the ejection speed caused by a reduction in driving voltage due to the impedance converter. For example, in case where the driving voltage is not reduced by the impedance converter, the ink may have a first ejection speed (e.g., an original ejection (or jetting) speed), as shown by reference numeral 1301 in FIG. 13A. However, in case where the impedance converter is located between the driver and the inkjet head, the driving voltage is reduced by a selected magnitude (e.g., about 0.7 V) by the characteristics of the impedance converter, as shown by reference numeral 1302 in FIG. 13A, resulting in a decrease of the ejection speed from the first ejection speed to a second ejection speed due to the reduction in the driving voltage. In order to compensate for this decrease in the ejection speed, increasing the driving voltage output from the driver by the same magnitude (e.g., about 0.7 V) decreased by the impedance converter may restore the ejection speed of the ink to match (or closely resemble) the first ejection speed (e.g., the original ejection speed), as shown by reference numeral 1303 in FIG. 13A. Thus, the inkjet printing system according to an embodiment may maintain ejection performance by compensating for the output voltage of the driver.

Referring to FIG. 13B, the inkjet printing system may experience a reduction in ejection speed depending on the number of nozzles being driven. For example, the maximum output current of the impedance converter should meet or exceed a total current required in case where all of the nozzles are driven. Specifically, in case where 8 nozzles are driven and each nozzle requires a current of about 100 mA, the impedance converter should provide a current of at least about 800 mA. For example, in case where the maximum output current of the impedance converter is about 700 mA, which is less than about 800 mA required, and 8 nozzles are driven, the driving voltage supplied to each nozzle may decrease, as shown by reference numeral 1304 in FIG. 13B. The ejection speed of each nozzle may also decrease. This may occur due to a limitation (or limit) in the maximum output current of the impedance converter, resulting in a reduced current per nozzle (e.g., 87.5 mA=700 mA/8) compared to the current required to drive each nozzle (e.g., about 100 mA). On the other hand, in case where only one of 8 nozzles is driven, the impedance converter may sufficiently provide the required current (e.g., about 100 mA) for that single nozzle, as shown by reference numeral 1305 in FIG. 13B. In this configuration, the driving voltage and the ejection speed may not be reduced or remain unaffected. Therefore, in order to prevent a reduction in ejection speed in the case of driving multiple nozzles, the impedance converter should consider the driving voltage magnitude for each nozzle (e.g., piezo element), the maximum driving current required to simultaneously drive all nozzles, and/or the slew rate.

Although not shown in FIGS. 13A and 13B, the ink ejection speed may be measured using equipment known as a drop watcher.

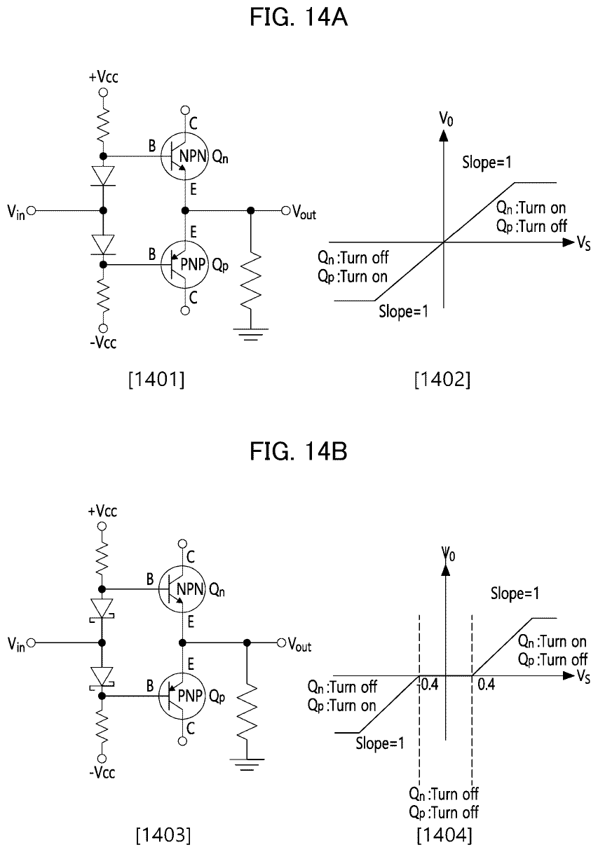

FIG. 14A is a schematic view illustrating an impedance converter using a class AB amplifier and its characteristic graph according to an embodiment, and FIG. 14B is a schematic view illustrating an impedance converter using a class AB amplifier and its characteristic graph according to another embodiment.

Referring to FIGS. 14A and 14B, an impedance converter according to an embodiment may include a class AB amplifier instead of the class B amplifier. In an embodiment, the impedance converter may be a class AB amplifier based on a PN diode, as shown by reference numeral 1401 in FIG. 14A. Specifically, the impedance converter in FIG. 14A may have a configuration in which a positive voltage +Vcc is applied to a collector C and a base B of an NPN type BJT Qn, a negative voltage (−Vcc) is applied to a collector C and a base B of a PNP type BJT Qp, a PN diode (hereinafter, referred to as a first PN diode) is connected between the base B of the NPN type BJT Qn and an input terminal Vin (e.g., which receives a driving voltage), a PN diode (hereinafter, referred to as a second PN diode) is connected between the input terminal Vin and the base B of the PNP type BJT Qp, and an emitter E of the NPN type BJT Qn and an emitter E of the PNP type BJT Qp are connected to an output terminal Vout (e.g., which is connected to the inkjet head 100). The impedance converter may have barely crossover distortion, as shown in the characteristic graph shown by reference numeral 1402 in FIG. 14A.

According to another embodiment, the impedance converter may be a class AB amplifier based on a Schottky diode, as shown by reference numeral 1403 in FIG. 14B. Specifically, in the impedance converter of FIG. 14B, the first PN diode and the second PN diode in FIG. 14A may be replaced with a first Schottky diode and a second Schottky diode. The impedance converter may have a crossover distortion section of about −0.4 V to about 0.4 V, which is similar to the crossover distortion section of a class B amplifier (about −0.7 V to about 0.7 V), as shown in the characteristic graph shown by reference numeral 1404 in FIG. 14B.

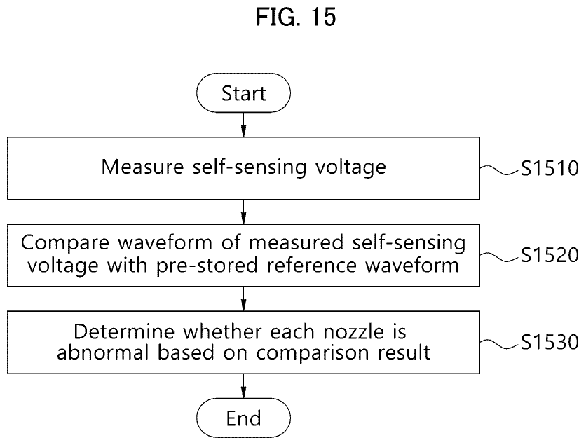

FIG. 15 is a schematic flowchart illustrating a method of monitoring nozzle states of an inkjet printing system according to an embodiment.

Referring to FIG. 15, the method of monitoring nozzle states of an inkjet printing system according to an embodiment may include an operation (S1510) of measuring a self-sensing voltage. For example, the self-sensing circuit part in the inkjet printing system according to embodiments described above may measure (or monitor) the self-sensing voltage of each nozzle. The inkjet printing system may include: an inkjet head including multiple nozzles for ejecting ink; a driver that controls driving of the nozzles to eject the ink; an impedance converter located between the driver and the inkjet head and having an output impedance which varies based on the magnitude of an input voltage; and a self-sensing circuit part connected to an input terminal of the inkjet head, which measures self-sensing voltage of each nozzle. Each component of the inkjet printing system has been described above, and therefore will not be described in detail.

The method may include an operation (S1520) of comparing waveforms of the measured self-sensing voltages with a pre-stored reference waveform. For example, the control device (or the self-sensing circuit part) in the inkjet printing system according to embodiments described above may compare the waveforms of the measured self-sensing voltages with the pre-stored reference waveform and calculate a similarity. The reference waveform may represent a waveform of the self-sensing voltage which is previously measured and stored in case where each nozzle is in a normal state.

The method may include an operation (S1530) of determining whether each nozzle is abnormal (or monitoring the state of the nozzle) based on the comparison result. For example, in case where the similarity is within a reference value, the control device (or the self-sensing circuit part) in the inkjet printing system according to embodiments may determine that the corresponding nozzle is in a normal state. On the other hand, in case where the similarity deviates from the reference value, the control device (or the self-sensing circuit part) may determine that the corresponding nozzle is in an abnormal state.

Although not shown in the drawings, the method may further include an operation of providing an alarm to a user in various ways in case where a nozzle defect is detected. The inkjet printing system may provide a visual alarm (e.g., displaying a warning message, blinking a designated light source, etc.), an auditory alarm (e.g., emitting a designated sound effect), a tactile alarm (e.g., producing a vibration in a designated pattern), etc. using (or via) a designated external device (e.g., a portable terminal used by a manager).

Various embodiments may perform effective self-sensing (e.g., acquiring a high-quality self-sensing signal) without affecting ejecting (or jetting) (e.g., while preventing (or minimizing) distortion of the driving voltage) by incorporating an impedance converter between the driver and the inkjet head. This impedance converter may have an output impedance that varies based on its input or output voltage. For example, in embodiments, the output impedance may decrease in case where a high voltage (e.g., the driving voltage of the inkjet head) is input, allowing the voltage to be delivered to the inkjet head without loss (or with minimal loss) of the driving voltage. Conversely, the output impedance may increase in case where a low input voltage for piezo element (e.g., the self-sensing voltage) is applied, ensuring that the self-sensing voltage is not affected (e.g., not dissipated or reduced) by the driver. This configuration may improve the speed, accuracy, and/or efficiency of monitoring nozzle states. It may enable effective driving and self-sensing of the nozzles. The benefits of these embodiments are not limited to the examples provided above and may include further advantages understood by those skilled in the art from the description.

A display device manufactured using the inkjet printing system according to an embodiment can be applied to various electronic devices. The electronic device according to an embodiment includes the display device described above, and may further include modules or devices having additional functions in addition to the display device.

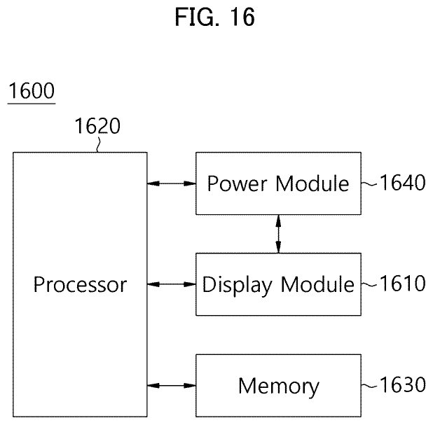

FIG. 16 is a block diagram of an electronic device according to an embodiment.

Referring to FIG. 16, the electronic device 1600 according to an embodiment may include a display module 1610, a processor 1620, a memory 1630, and a power module 1640.

The processor 1620 may include at least one of a central processing unit CPU, an application processor AP, a graphic processing unit GPU, a communication processor CP, an image signal processor ISP, and a controller.

The memory 1630 may store data information necessary for the operation of the processor 1620 or the display module 1610. When the processor 1620 executes an application stored in the memory 1630, an image data signal and/or an input control signal is transmitted to the display module 1610, and the display module 1610 can process the received signal and output image information through the display screen.

The power module 1640 may include a power supply module such as a power adapter or a battery device, and a power conversion module that converts the power supplied by the power supply module to generate power necessary for the operation of the electronic device 1600.

At least one of the components of the electronic device 1600 described above may be included in the display device according to the embodiments described above. In addition, some of the individual modules functionally included in one module may be included in the display device, and other modules may be provided separately from the display device. For example, the display device may include the display module 1610, and the processor 1620, the memory 1630, and the power module 1640 may be provided in the form of other devices within the electronic device 1600, other than the display device.

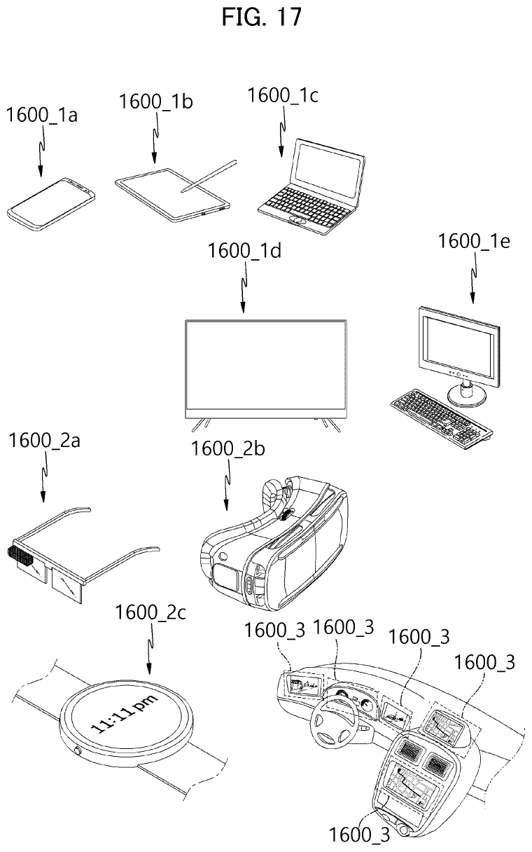

FIG. 17 is a schematic diagram of an electronic device according to various embodiments.

Referring to FIG. 17, various electronic devices to which display devices according to embodiments are applied may include not only electronic devices for displaying an image such as a smart phone 1600_1a, a tablet PC 1600_1b, a laptop 1600_1c, a TV 1600_1d, and a desk monitor 1600_1e, but also wearable electronic devices including display modules such as smart glasses 1600_2a, a head mounted display 1600_2b, and a smart watch 1600_2c, and vehicle electronic devices 1600_3 including display modules such as a dashboard (or instrument panel) of an automobile, center fascia, a CID (Center Information Display) arranged on the dashboard, and a room mirror display.

The term “module” used in embodiments may include a unit implemented in hardware, software or firmware way, and for example, may be used interchangeably with the terms such as logic, a logic block, a part, or a circuit. The module may be a part integrally formed therewith, or a minimum unit of the part or a portion thereof which performs one or more functions. For example, according to an embodiment, the module may be implemented in a form of an application-specific integrated circuit (ASIC).

Various embodiments may be implemented by software (e.g., a program) including one or more instructions stored in a storage medium (e.g., an internal memory or an external memory) readable by a machine. For example, a processor of the machine may call, among one or more instructions stored in the storage medium, at least one instruction, and may execute the instruction. This allows at least one function to be performed according to the called at least one instruction. The one or more instructions may include a code that is made by a compiler or a code that may be executed by an interpreter. The storage medium that may be read by a device may be provided in a form of a non-transitory storage medium. Here, the ‘non-transitory storage medium’ means that the storage medium is a tangible device and does not include a signal (e.g., an electromagnetic wave), and with regard to the term, a case, in which data are semi-permanently stored in the storage medium, and a case, in which data are temporarily stored in the storage medium, are not distinguished.

According to an embodiment, the methods according to embodiments may be provided to be included in a computer program product. The computer program product may be traded between a seller and a purchaser. The computer program product may be distributed in a form of a storage medium that may be read by a device (e.g., a compact disk read only memory (CD-ROM)) or may be distributed (e.g., downloaded or uploaded) through an application store or directly or online between two user devices. In the online distribution, at least a portion of the computer program product may be at least temporarily stored in a storage medium, such as a server of a manufacturer, a server of an application store, or a memory of a relay server, which may be read by a device, or temporarily generated.

According to embodiments, each component or element (e.g., a module or program) of the above-described components or elements may include one or a plurality of entities, and some of the plurality of entities may be disposed to other components with being separated therefrom. According to embodiments, among the above-described components, one or more components or operations thereof may be omitted or one or more other components or operations thereof may be added to the components. Alternatively or additionally, the plurality of components (e.g., the modules or programs) may be integrated into one component. In this case, the integrated components may perform one or more functions of each component of the plurality of components in a way that they are the same as or similar to the functions performed by the corresponding components among the plurality of components before the integration. According to embodiments, operations performed by the modules, programs, or other components may be executed sequentially, in parallel, repeatedly, or heuristically, one or more operations may be executed in another sequence or omitted, or one or more other operations may be added thereto.

Embodiments have been disclosed herein, and although terms are employed, they are used and are to be interpreted in a generic and descriptive sense only and not for purpose of limitation. In some instances, as would be apparent by one of ordinary skill in the art, features, characteristics, and/or elements described in connection with an embodiment may be used singly or in combination with features, characteristics, and/or elements described in connection with other embodiments unless otherwise specifically indicated. Accordingly, it will be understood by those of ordinary skill in the art that various changes in form and details may be made without departing from the spirit and scope of the disclosure as set forth in the following claims.

What is claimed is:

1. An inkjet printing system comprising:
an inkjet head including a plurality of nozzles that eject ink;
a driver that controls driving of the plurality of nozzles;
an impedance converter located between the driver and the inkjet head, the impedance converter having an impedance which varies based on a magnitude of an input voltage of the impedance converter provided by the driver; and
a self-sensing circuit part connected to an input terminal of the inkjet head and an output terminal of the impedance converter, the self-sensing circuit part measuring a self-sensing voltage for each nozzle.

2. The inkjet printing system of claim 1, wherein the impedance converter has a low impedance in case that the input voltage of the impedance converter is within a jetting voltage range and a high impedance in case that the input voltage of the impedance converter approaches zero after jetting.

3. The inkjet printing system of claim 1, wherein the impedance converter comprises a class B amplifier having a complementary push-pull structure, a class AB amplifier based on a PN diode, or
a class AB amplifier based on a Schottky diode.

4. The inkjet printing system of claim 1, wherein the driver comprises a driving signal generator that generates a driving signal of a designated waveform for driving the nozzles.

5. The inkjet printing system of claim 4, wherein the driver further comprises a power amplifier that amplifies the generated driving signal.

6. The inkjet printing system of claim 1, wherein the self-sensing circuit part comprises:
a differential amplifier that extracts a self-sensing signal by removing a driving voltage from an output voltage signal of the impedance converter;
a signal processor that amplifies and filters the extracted self-sensing signal; and
a data collector that collects and stores the amplified and filtered self-sensing signal.

7. The inkjet printing system of claim 1, wherein the impedance converter is embedded in the driver.

8. The inkjet printing system of claim 7, wherein the self-sensing circuit part is embedded in the driver.

9. The inkjet printing system of claim 1, wherein the impedance converter is embedded in the inkjet head.

10. The inkjet printing system of claim 9, wherein the self-sensing circuit part is embedded in the inkjet head.

11. The inkjet printing system according to claim 1, wherein
the plurality of nozzles included in the inkjet head are divided into a plurality of nozzle groups,
the driver includes a plurality of drivers that drive the plurality of nozzle groups, respectively,
the impedance converter includes a plurality of impedance converters located between the plurality of nozzle groups and the plurality of drivers, respectively, and
the self-sensing circuit part extracts, in case that one of a plurality of nozzles included in a first nozzle group and a second nozzle group is driven, a self-sensing voltage for the nozzle driven by differentially amplifying a self-sensing signal of the first nozzle group and a self-sensing signal of the second nozzle group.

12. The inkjet printing system of claim 1, wherein the self-sensing circuit part extracts a self-sensing voltage for each nozzle based on a difference between an output voltage signal of the impedance converter and an input voltage signal of the impedance converter.

13. The inkjet printing system of claim 1, further comprising a reference voltage generator which includes an equivalent impedance converter equal to the impedance converter, and an equivalent capacitor having a capacitance equal to one of the plurality of nozzles, wherein
the self-sensing circuit part extracts a self-sensing voltage for each nozzle by subtracting an output voltage signal of the reference voltage generator from an output voltage signal of the impedance converter.

14. The inkjet printing system of claim 1, wherein the driver outputs a voltage increased by an amount equal to a voltage drop caused by the impedance converter as a driving voltage.

15. The inkjet printing system of claim 1, wherein a maximum allowable current of the impedance converter is greater than a total current in case that all nozzles driven by the driver are activated.

16. The inkjet printing system of claim 1, further comprising a control device that:
controls driving of the driver, and
determines whether each nozzle is abnormal by comparing a waveform of the self-sensing voltage of each nozzle measured by the self-sensing circuit part with a pre-stored reference waveform.

17. The inkjet printing system of claim 1, wherein each of the plurality of nozzles comprises:
a switch having one terminal connected to the impedance converter and turned on or off based on a control signal; and
a piezo element having one terminal connected to another terminal of the switch and another terminal connected to ground, the piezo element generating a pressure wave to eject ink.

18. The inkjet printing system of claim 1, wherein the self-sensing circuit part monitors a state of each nozzle by comparing a waveform of the measured self-sensing voltage of each nozzle with a pre-stored reference waveform.

19. A method of monitoring nozzle states of an inkjet printing system, the inkjet printing system comprising: an impedance converter located between an inkjet head including a plurality of nozzles and a driver that controls driving of the plurality of nozzles, the impedance converter having an impedance which varies based on a magnitude of an input voltage of the impedance converter provided by the driver; and a self-sensing circuit part connected to an input terminal of the inkjet head and an output terminal of the impedance converter, the method comprising:
measuring a self-sensing voltage of one of the plurality of nozzles using the self-sensing circuit part;
comparing a waveform of the measured self-sensing voltage with a pre-stored reference waveform to obtain a comparison result; and
determining whether the nozzle is abnormal based on the comparison result.

20. An electronic device comprising a display device manufactured using the inkjet printing system of claim 1.
